(19) United States
(12) Patent Application Publication
(10) Pub. No.: US 2018/0305243 A1
(43) Pub. Date: Oct. 25, 2018

(54) METHOD FOR MANUFACTURING WAVELENGTH CONVERSION MEMBER AND WAVELENGTH CONVERSION MEMBER

(71) Applicant: NIPPON ELECTRIC GLASS CO., LTD., Otsu-shi, Shiga (JP)

(72) Inventors: Masaaki KADOMI, Otsu-shi (JP); Takashi NISHIMIYA, Otsu-shi (JP); Hideki ASANO, Otsu-shi (JP)

(21) Appl. No.: 15/766,017

(22) PCT Filed: Aug. 10, 2016
(86) PCT No.: PCT/JP2016/073596

§ 371 Date: Apr. 5, 2018

(30) Foreign Application Priority Data
Nov. 13, 2015 (JP) 2015-222791

(51) Int. Cl. C03C 8/14; C09K 11/02; C09K 11/88; C03C 8/08; C03C 3/247; C03C 4/12

(52) U.S. Cl. CPC C03C 8/14; C09K 11/025; C09K 11/883; C03C 8/08; B82Y 20/00; C03C 4/12; C03C 2204/00; C03C 2205/00; C03C 3/247

(57) ABSTRACT

Provided are a method for manufacturing a wavelength conversion member that can suppress the reaction between inorganic nanophosphor particles and glass to suppress the deterioration of the inorganic nanophosphor particles, and the wavelength conversion member. The method for manufacturing a wavelength conversion member according to the present invention includes the steps of: forming inorganic protective films 5 on surfaces of inorganic nanophosphor particles 1; and mixing the inorganic nanophosphor particles 1 having the inorganic protective films 5 formed thereon with glass powder and firing a resultant mixture in a temperature range where the inorganic protective films 5 survive.

### TECHNICAL FIELD

The present invention relates to methods for manufacturing wavelength conversion members, and wavelength conversion members.

### BACKGROUND ART

Recently, studies have been made on light emitting devices in which an excitation light source, such as a light emitting diode (LED) or a semiconductor laser diode (LD), is used, excitation light generated from the excitation light source is applied to a phosphor, and fluorescence thus generated is used as illuminating light. Furthermore, studies have also been made on the use, as a phosphor, of inorganic nanophosphor particles called semiconductor nanoparticles or quantum dots. Inorganic nanophosphor particles can be controlled in fluorescence wavelength by changing their diameter and have high luminous efficiency.

However, inorganic nanophosphor particles have the property of being easily deteriorated by contact with moisture or oxygen in the air. Therefore, inorganic nanophosphor particles need to be used in a sealed state to avoid contact with the external environment. If resin is used as a sealing material, part of energy during wavelength conversion of excitation light using a phosphor is converted to heat, which presents the problem that the resin is discolored by the heat. In addition, resin is poor in water resistance and permeable to water, which presents the problem that the phosphor is likely to deteriorate.

Patent Literature 1 proposes a wavelength conversion member in which glass is used as a sealing material in place of resin. Specifically, Patent Literature 1 proposes a wavelength conversion member in which glass is used as a sealing material by firing a mixture containing inorganic nanophosphor particles and glass powder.

### CITATION LIST

### Patent Literature

[PTL 1]
JP-A-2012-87162

### SUMMARY OF INVENTION

### Technical Problem

However, when the mixture containing inorganic nanophosphor particles and glass powder is fired to seal the inorganic nanophosphor particles in glass, there arises the problem that the inorganic nanophosphor particles react with the glass to deteriorate.

An object of the present invention is to provide a method for manufacturing a wavelength conversion member that can suppress the reaction between inorganic nanophosphor particles and glass to suppress the deterioration of the inorganic nanophosphor particles, and to provide the wavelength conversion member.

### Solution to Problem

A method for manufacturing a wavelength conversion member according to the present invention includes the steps of: forming inorganic protective films on surfaces of inorganic nanophosphor particles; and mixing the inorganic nanophosphor particles having the inorganic protective films formed thereon with glass powder and firing a resultant mixture in a temperature range where the inorganic protective films survive.

The inorganic protective films are preferably SiO₂-based protective films.

In the present invention, the inorganic protective film may be formed on a surface of an aggregate formed of a plurality of the inorganic nanophosphor particles.

In the present invention, for example, the inorganic protective films can be formed by applying a sol solution for forming the inorganic protective films to the surfaces of the inorganic nanophosphor particles and then drying the sol solution.

The temperature range for the firing is preferably not more than 350° C.

The glass powder in the present invention is preferably at least one selected from the group consisting of SnO—P₂O₅-based glasses, SnO—P₂O₅—B₂O₃-based glasses, SnO—P₂O₅—F-based glasses, and Bi₂O₃-based glasses.

A wavelength conversion member according to the present invention includes inorganic nanophosphor particles, a glass matrix containing the inorganic nanophosphor particles dispersed therein, and inorganic protective layers provided between the inorganic nanophosphor particles and the glass matrix and having a different composition from the glass matrix.

The inorganic protective layers are preferably SiO₂-based protective layers.

The inorganic protective layer may be provided between an aggregate formed of a plurality of the inorganic nanophosphor particles and the glass matrix.

### ADVANTAGEOUS EFFECTS OF INVENTION

According to the present invention, the reaction between inorganic nanophosphor particles and glass can be suppressed to suppress the deterioration of the inorganic nanophosphor particles.

### BRIEF DESCRIPTION OF DRAWINGS

FIG. 1 is a schematic cross-sectional view showing a wavelength conversion member according to one embodiment of the present invention.

FIG. 2 is a schematic cross-sectional view showing inorganic nanophosphor particles with an inorganic protective film formed on the surfaces thereof.

### DESCRIPTION OF EMBODIMENTS

Hereinafter, a description will be given of a preferred embodiment. However, the following embodiment is merely illustrative and the present invention is not limited to the following embodiment. Throughout the drawings, members having substantially the same functions may be referred to by the same reference characters.

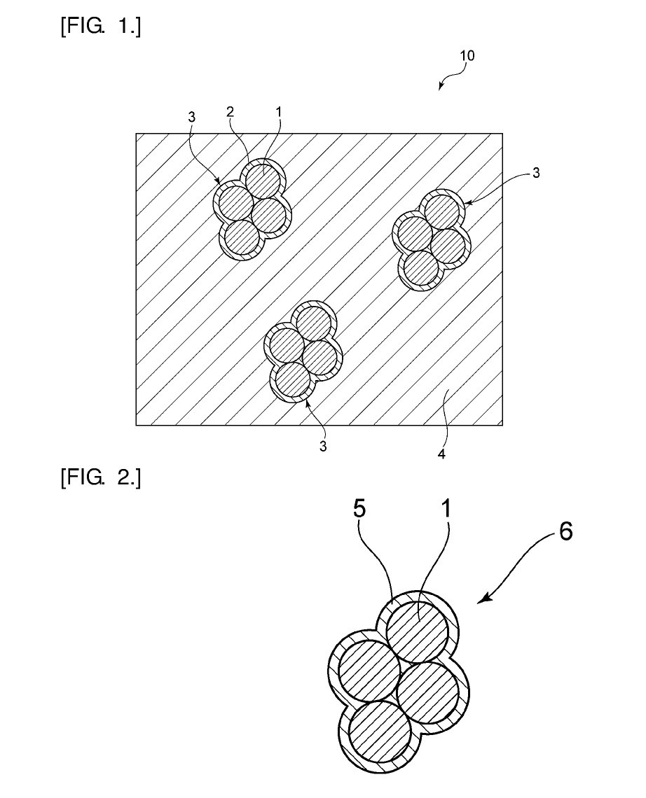

FIG. 1 is a schematic cross-sectional view showing a wavelength conversion member according to one embodiment of the present invention. As shown in FIG. 1, a wavelength conversion member 10 according to this embodiment includes inorganic nanophosphor particles 1, a glass matrix 4 containing the inorganic nanophosphor particles 1 dispersed therein, and inorganic protective layers 2 provided between the inorganic nanophosphor particles 1 and the glass matrix 4 and having a different composition from the glass matrix 4. In this embodiment, the inorganic protective layers 2 are formed on the surfaces of aggregates each formed of a plurality of inorganic nanophosphor particles 1 to form protective layer-deposited phosphor particles 3. Therefore, the wavelength conversion member 10 is formed so that the protective layer-deposited phosphor particles 3 are dispersed in the glass matrix 4.

A description will be given below of a method for manufacturing a wavelength conversion member 10 according to this embodiment.

FIG. 2 is a schematic cross-sectional view showing inorganic nanophosphor particles with an inorganic protective film formed on the surfaces thereof. Protective film-deposited phosphor particles 6 shown in FIG. 2 are made up by forming an inorganic protective film 5 on the surfaces of inorganic nanophosphor particles 1. In this embodiment, the inorganic protective film 5 is formed on the surface of each aggregate formed of a plurality of inorganic nanophosphor particles 1. The inorganic protective film 5 becomes an inorganic protective layer 2 shown in FIG. 1 after undergoing firing. Furthermore, the protective film-deposited phosphor particles 6 become protective layer-deposited phosphor particles 3 shown in FIG. 1 after undergoing firing. In the manufacturing method according to this embodiment, first, inorganic protective films 5 are formed on the surfaces of the inorganic nanophosphor particles 1 to produce protective film-deposited phosphor particles 6.

The inorganic nanophosphor particles 1 that can be used are phosphor particles made of inorganic crystals having a particle diameter of less than 1 μm. Examples of such inorganic nanophosphor particles that can be used include those generally called semiconductor nanoparticles or quantum dots. Examples of the semiconductor of such inorganic nanophosphor particles include group II-VI compounds and group III-V compounds.

Examples of the group II-VI compounds that can be cited include CdS, CdSe, CdTe, ZnS, ZnSe, and ZnTe. Examples of the group III-V compounds that can be cited include InP, GaN, GaAs, GaP, AlN, AlP, AlSb, InN, InAs, and InSb. At least one or a composite of two or more selected from the above compounds can be used as the inorganic nanophosphor particles in the present invention. Examples of the composite that can be cited include those having a core-shell structure, for example, a composite having a core-shell structure in which the surfaces of CdSe particles are coated with ZnS.

The particle diameter of the inorganic nanophosphor particles 1 is appropriately selected within a range of, for example, not more than 100 nm, preferably not more than 50 nm, particularly preferably 1 to 30 nm, more preferably 1 to 15 nm, or still more preferably 1.5 to 12 nm.

In this embodiment, the inorganic protective films 5 are formed on the surfaces of individual aggregates each formed of a plurality of inorganic nanophosphor particles 1. The formation of inorganic protective films 5 on the surfaces of the aggregates enables suppression of the reaction between the glass matrix 4 and the inorganic nanophosphor particles 1, resulting in suppression of the deterioration of the inorganic nanophosphor particles 1. The size of the aggregates is, in diameter, preferably 20 to 1000 nm and more preferably 100 to 700 nm. Although in this embodiment the inorganic protective films 5 are formed on the surfaces of individual aggregates, the present invention is not limited to this and the inorganic protective films 5 may be formed on the surfaces of individual single inorganic nanophosphor particles 1.

No particular limitation is placed on the type of the inorganic protective films 5 so long as in mixing protective film-deposited phosphor particles 6 and glass powder and firing the glass powder to make a glass matrix 4, the inorganic protective films 5 can suppress the reaction between the glass matrix 4 and the inorganic nanophosphor particles 1. Specific examples of the inorganic protective film 5 that can be cited are oxide-based protective films, including SiO₂-based protective films and ZrO₂-based protective films.

The amount of inorganic protective film 5 deposited on the inorganic nanophosphor particles 1 is, per part by volume of inorganic nanophosphor particles 1, preferably 37 to 4.5×10⁶ parts by volume of inorganic protective film 5, more preferably 1.0×10³ to 3.0×10⁶ parts by volume of inorganic protective film 5, and still more preferably 4.5×10³ to 1.6×10⁶ parts by volume of inorganic protective film 5. If the amount of inorganic protective film 5 deposited is too small, the reaction between the glass matrix 4 and the inorganic nanophosphor particles 1 may not be able to be sufficiently suppressed. On the other hand, if the amount of inorganic protective film 5 deposited is too large, the luminescence intensity of the inorganic nanophosphor particles 1 may decrease.

The inorganic protective films 5 can be deposited on the surfaces of the inorganic nanophosphor particles 1, for example, by bringing a sol solution prepared by the sol-gel method into contact with the inorganic nanophosphor particles 1 and then drying the sol solution. An example of the method for bringing the sol solution into contact with the inorganic nanophosphor particles 1 is the method of adding the inorganic nanophosphor particles 1 into the sol solution and mixing them.

In the case where the inorganic protective films 5 are made of a metal oxide, the sol solution can be prepared by hydrolyzing a metal alkoxide compound with an acid or a base. In the case where the inorganic protective films 5 are SiO₂-based protective films, a silicon alkoxide compound, such as tetraethoxysilane or tetramethoxysilane, is hydrolyzed to prepare a SiO₂-based sol solution. This sol solution is mixed with the inorganic nanophosphor particles 1 and then dried, so that SiO₂-based protective films can be deposited on the surfaces of the inorganic nanophosphor particles 1.

Next, in the manufacturing method according to this embodiment, the inorganic nanophosphor particles 1 with inorganic protective films 5 formed thereon, i.e., the protective film-deposited phosphor particles 6, are mixed with glass powder. When this mixture is fired, the protective film-deposited phosphor particles 6 become protective layer-deposited phosphor particles 3, so that a wavelength conversion member 10 can be produced in which the protective layer-deposited phosphor particles 3 are homogeneously dispersed in a glass matrix 4.

Examples of the method for mixing the protective film-deposited phosphor particles 6 with the glass powder include the method of adding the glass powder 6 into a liquid containing the protective film-deposited phosphor particles 6 dispersed therein and the method of impregnating a preform of the glass powder with the liquid containing the protective film-deposited phosphor particles 6 dispersed therein. An example of the preform of glass powder is a pressed powder obtained by forming the glass powder into shape by the application of pressure and heat.

No particular limitation is placed on the dispersion medium into which the protective film-deposited phosphor particles 6 are to be dispersed so long as it can disperse the protective film-deposited phosphor particles 6. Generally, non-polar solvents having suitable volatility, such as hexane and octane, can be preferably used. However, the dispersion mediums to be used are not limited to the above and may be polar solvents having suitable volatility.

The firing is conducted in a temperature range where the inorganic protective films 5 of the protective film-deposited phosphor particles 6 survive as inorganic protective layers 2. Specifically, the firing temperature is preferably 350° C. or less, more preferably 300° C. or less, and still more preferably 250° C. or less. By lowering the firing temperature, the reaction between the inorganic nanophosphor particles 1 and the glass matrix 4 can be further suppressed.

The atmosphere during the firing is preferably a vacuum atmosphere or an inert atmosphere using nitrogen or argon. Thus, the deterioration and discoloration of the glass powder during sintering can be suppressed. Particularly in a vacuum atmosphere, the formation of bubbles in the wavelength conversion member 10 can be suppressed.

From the viewpoint of lowering the firing temperature, the glass powder preferably has a low softening point. Specifically, the preferred glass powder to be used is one made of a glass having a softening point of preferably 350° C. or less, more preferably 300° C. or less, and still more preferably 250° C. or less.

Examples of such glass powder that can be cited include SnO—P₂O₅-based glasses, SnO—P₂O₅—B₂O₃-based glasses, SnO—P₂O₅—F-based glasses, and Bi₂O₃-based glasses.

The preferred SnO—P₂O₅-based glasses are those having a glass composition of, in % by mole, 40 to 85% SnO and 15 to 60% P₂O₅ and the particularly preferred SnO—P₂O₅-based glasses are those having a glass composition of, in % by mole, 60 to 80% SnO and 20 to 40% P₂O₅.

The preferred SnO—P₂O₅—B₂O₃-based glasses are those having a glass composition of, in % by mole, 35 to 80% SnO, 5 to 40% P₂O₅, and 1 to 30% B₂O₃.

The SnO—P₂O₅-based glasses and the SnO—P₂O₅—B₂O₃-based glasses may further contain, as optional components, 0 to 10% Al₂O₃, 0 to 10% SiO₂, 0 to 10% Li₂O, 0 to 10% Na₂O, 0 to 10% K₂O, 0 to 10% MgO, 0 to 10% CaO, 0 to 10% SrO, and 0 to 10% BaO. They may further contain, in addition to the above components, a component for improving weatherability, such as Ta₂O₅, TiO₂, Nb₂O₅, Gd₂O₃ or La₂O₃, and a component for stabilizing the glass, such as ZnO.

The preferred SnO—P₂O₅—F-based glasses are those containing, in % by cation, 10 to 70% P⁵⁻ and 10 to 90% Sn²⁺ and, in % by anion, 30 to 100% O²⁻ and 0 to 70% F⁻. In order to improve weatherability, they may further contain B³⁺, Si⁴⁺, Al³⁺, Zn²⁺ or Ti⁴⁺ in a total content of 0 to 50%.

The preferred Bi₂O₃-based glasses are those having a glass composition of, in % by mass, 10 to 90% Bi₂O₃ and 10 to 30% B₂O₃. They may further contain, as glass-forming components, SiO₂, Al₂O₃, B₂O₃, and P₂O₅, each in a content of 0 to 30%.

From the viewpoint of lowering the softening point of the SnO—P₂O₅-based glasses and SnO—P₂O₅—B₂O₃-based glasses and stabilizing the glass, the molar ratio between SnO and P₂O₅ (SnO/P₂O₅) is preferably in a range of 0.9 to 16, more preferably in a range of 1.5 to 10, and still more preferably in a range of 2 to 5. If the molar ratio (SnO/P₂O₅) is too small, this makes the firing at low temperatures difficult, so that the inorganic nanophosphor particles may be likely to deteriorate during sintering. In addition, the weatherability may be excessively low. On the other hand, if the molar ratio (SnO/P₂O₅) is too high, the glass may be likely to devitrify and thus have excessively low transmission.

The average particle diameter D50 of the glass powder is preferably 0.1 to 100 μm and particularly preferably 1 to 50 μm. If the average particle diameter D50 of the glass powder is too small, bubbles are likely to form during sintering. Thus, the mechanical strength of the resultant wavelength conversion member may be decreased. Furthermore, owing to bubbles formed in the wavelength conversion member, light-scattering loss may be increased to decrease the luminous efficiency. On the other hand, if the average particle diameter D50 of the glass powder is too large, the inorganic nanophosphor particles are less likely to be homogeneously dispersed in the glass matrix, so that the luminous efficiency of the resultant wavelength conversion member may be low. The average particle diameter D50 of the glass powder can be measured with a laser diffraction particle size distribution measurement device.

In the above manner, the wavelength conversion member 10 shown in FIG. 1 can be produced.

### EXAMPLES

<Production of Wavelength Conversion Member>

### Example 1

Inorganic nanophosphor particles were used which have a core-shell structure of CdSe (core)/ZnS (shell) and a particle diameter of 3 nm (green) and those having the same core-shell structure and a particle diameter of 6 nm (red). The concentration of inorganic nanophosphor particles in toluene was controlled to 3 μM and tetraethoxysilane was added into the toluene solution to reach 0.02 μM, followed by stirring for 20 hours. Next, 1.5 g of aerosol OT was added into 10 ml of toluene, followed by mixing. Then, 0.3 ml of the above solution of inorganic nanophosphor particles was added to the mixture, 0.3 ml of 6.25% by mass aqueous ammonia solution was further added to the mixture, and 20 μl of tetraethoxysilane was further added to the mixture, followed by stirring for 20 hours. Thereafter, the mixture was dried at 50° C. to prepare protective film-deposited phosphor particles. In the obtained protective film-deposited phosphor particles, aggregates formed of about one to five inorganic nanophosphor particles were each coated with an inorganic protective film. The average particle diameter of the aggregates was 200 nm. Furthermore, approximately 4.5×10³ to 1.3×10⁵ parts by volume of inorganic protective film was deposited on 1 part by volume of inorganic nanophosphor particles.

Glass powder was used which has a composition of, in % by cation, 56.3% Sn²⁺ and 43.8% P⁵⁺, a composition of, in % by anion, 24.8% F⁻ and 75.2% O²⁻, an average particle diameter D50 of 4 μm, and a softening point of 180° C. Heat and pressure were applied to the glass powder to prepare a pressed powder as a preform. The pressed powder was impregnated with a dispersion liquid in which the above protective film-deposited phosphor particles were contained in an amount of 20% by mass in toluene as a dispersion medium, and the dispersion medium was then removed, thus preparing a preform of glass powder having protective film-deposited phosphor particles mixed therein.

The preform was fired at a firing temperature of 150° C. in a vacuum atmosphere, thus producing a wavelength conversion member.

### Comparative Example 1

A wavelength conversion member was produced in the same manner as in Example 1 except that the firing temperature was 500° C.

### Comparative Example 2

Without preparing protective film-deposited phosphor particles, inorganic nanophosphor particles were directly dispersed into toluene as a dispersion medium so that they were contained in an amount of 20% by mass in the toluene, thus preparing a dispersion liquid. The dispersion liquid was added into a powder compact in the same manner as in Example 1, and a preform was prepared in the same manner as in Example 1. The preform was fired in the same manner as in Example 1, thus producing a wavelength conversion member.

<Evaluation of Luminescence Intensity>

While in Example 1 the obtained wavelength conversion member had the same color as the inorganic nanophosphor particles, the wavelength conversion member of Comparative Example 1 lost the color of the inorganic nanophosphor particles by firing. The wavelength conversion member of Comparative Example 2 had the same color as the inorganic nanophosphor particles.

When excitation light (having a wavelength of 465 nm) was applied to each wavelength conversion member, luminescence was observed in the wavelength conversion member of Example 1 but not observed in the wavelength conversion member of Comparative Example 1. Luminescence was observed in the wavelength conversion member of Comparative Example 2, but its luminescence intensity was lower compared to that in Example 1. As seen from this, in Example 1, the deterioration of inorganic nanophosphor particles due to firing and reaction with glass could be suppressed.

<Confirmation of Surviving Film>

The sol solution prepared in Example 1 was applied onto a glass plate having the same glass composition as the glass powder used in Example 1, thus forming a 20 nm thick inorganic protective film. The glass plate having the inorganic protective film formed thereon was fired at 150° C. like Example 1. After the firing, it was confirmed that the inorganic protective film survived as an inorganic protective layer on the glass plate.

Unlike this, when such a glass plate was fired at 500° C. like Comparative Example 1, the glass plate was melted and the survival of the inorganic protective film on its surface could not be confirmed.

### REFERENCE SIGNS LIST

1 . . . inorganic nanophosphor particle
2 . . . inorganic protective layer
3 . . . protective layer-deposited phosphor particle
4 . . . glass matrix
5 . . . inorganic protective film
6 . . . protective film-deposited phosphor particle
10 . . . wavelength conversion member

1. A method for manufacturing a wavelength conversion member, the method comprising the steps of:
forming inorganic protective films on surfaces of inorganic nanophosphor particles; and
mixing the inorganic nanophosphor particles having the inorganic protective films formed thereon with glass powder and firing a resultant mixture in a temperature range where the inorganic protective films survive.

2. The method for manufacturing a wavelength conversion member according to claim 1, wherein the inorganic protective films are SiO₂-based protective films.

3. The method for manufacturing a wavelength conversion member according to claim 1, wherein the inorganic protective film is formed on a surface of an aggregate formed of a plurality of the inorganic nanophosphor particles.

4. The method for manufacturing a wavelength conversion member according to claims 1, wherein the inorganic protective films are formed by applying a sol solution for forming the inorganic protective films to the surfaces of the inorganic nanophosphor particles and then drying the sol solution.

5. The method for manufacturing a wavelength conversion member according to claim 1, wherein the temperature range is not more than 350° C.

6. The method for manufacturing a wavelength conversion member according to claim 1, wherein the glass powder is at least one selected from the group consisting of SnO—P₂O₅-based glasses, SnO—P₂O₅—B₂O₃-based glasses, SnO—P₂O₅—F-based glasses, and Bi₂O₃-based glasses.

7. A wavelength conversion member comprising:
inorganic nanophosphor particles;
a glass matrix containing the inorganic nanophosphor particles dispersed therein; and
inorganic protective layers provided between the inorganic nanophosphor particles and the glass matrix and having a different composition from the glass matrix.

8. The wavelength conversion member according to claim 7, wherein the inorganic protective layers are SiO₂-based protective layers.

9. The wavelength conversion member according to claim 7, wherein the inorganic protective layer is provided between an aggregate formed of a plurality of the inorganic nanophosphor particles and the glass matrix.
